(19) United States
(12) Patent Application Publication
(10) Pub. No.: US 2026/0328019 A1
(43) Pub. Date: Oct. 22, 2026

(54) VEHICLE HANDLE REGISTRATION FIXTURE

(71) Applicant: Rivian IP Holdings, LLC, Irvine, CA (US)

(72) Inventors: Vijay SRINIVASAN, Orange, CA (US); Reggie Kartak LAU, Irvine, CA (US); Kosta PAPANIKOLAOU, Corona, CA (US)

(21) Appl. No.: 19/182,454

(22) Filed: Apr. 17, 2025

(51) Int. Cl. E05B 3/00

(52) U.S. Cl. CPC E05B 3/00

(57) ABSTRACT

A fixture for installing a handle on a vehicle includes a lateral clearance member configured to receive a handle and occupy a gap between the handle and an opening defined by a panel. The fixture further includes a longitudinal positioning member secured to the lateral clearance member and configured to position the handle in a longitudinal direction perpendicular to the opening. One or more retainers are secured to the longitudinal positioning member and configured to selectively draw the longitudinal positioning member into alignment with the opening along the longitudinal direction. Handle installation may include fitting the lateral clearance member onto a handle of a handle assembly; inserting the handle and lateral clearance member into the opening in the panel; mounting the handle assembly to the panel; extending the handle from the opening following mounting of the handle assembly to the panel; and removing the lateral clearance member from the handle.

### INTRODUCTION

The present disclosure relates to a fixture for registering a handle with respect to a vehicle during installation.

### SUMMARY

The present disclosure describes an approach for installing a handle on a vehicle, such as flush-mounted handle. In one aspect, a fixture includes a lateral clearance member configured to receive a handle and occupy a gap between the handle and an opening defined by a panel. The fixture further includes a longitudinal positioning member secured to the lateral clearance member and configured to position the handle in a longitudinal direction perpendicular to the opening. One or more retainers are secured to the longitudinal positioning member and configured to selectively draw the longitudinal positioning member into alignment with the opening along the longitudinal direction.

In another aspect, a method for installation includes fitting a lateral clearance member onto a handle of a handle assembly; inserting the handle and lateral clearance member into an opening in a panel such that that lateral clearance member maintains a gap between the handle and the opening; mounting the handle assembly to the panel; extending the handle from the opening following mounting of the handle assembly to the panel; and removing the lateral clearance member from the handle.

### BRIEF DESCRIPTION OF THE DRAWINGS

FIG. 1A illustrates an example vehicle that may be operated in accordance with certain embodiments.

FIG. 1B illustrates a chassis of a vehicle having multiple drive units that may be operated in accordance with certain embodiments.

FIG. 2A is a schematic block diagram of a control system of a vehicle in accordance with certain embodiments.

FIG. 2B is a schematic block diagram of an alternative control system of a vehicle in accordance with certain embodiments.

FIGS. 3A and 3B are isometric views of a handle registration fixture in accordance with certain embodiments.

FIG. 4 is an isometric view of retainers for holding the handle registration fixture and handle in position relative to the vehicle in accordance with certain embodiments.

FIGS. 5A and 5B are isometric views illustrating retainers mounted to the handle registration fixture in accordance with certain embodiments.

FIGS. 6A to 6D are isometric views illustrating mounting of the handle registration fixture to a handle in accordance with certain embodiments.

FIGS. 7A to 7C are isometric views illustrating the use of the handle registration fixture to install a handle onto a door of a vehicle in accordance with certain embodiments.

FIGS. 8A to 8F are isometric views illustrating removal of the handle registration fixture from the handle following installation in accordance with certain embodiments.

### DETAILED DESCRIPTION

Flush-mounted door handles present a challenge since they must be precisely aligned in three dimensions with respect to the vehicle panels to which they are mounted. A handle registration fixture as disclosed herein slides onto the handle of a handle assembly including a mounting bracket and possibly an actuator. The handle registration fixture includes twist-lock retainers that have a first position aligned with the handle that permits the retainers to fit through a handle opening in a vehicle panel and a second position extending outwardly from the handle opening to rest on an outer surface of the vehicle panel in order to retain the handle relative to the vehicle panel. The handle registration fixture extends around the perimeter of the handle to maintain a gap thickness around the handle and the retainers maintain the position of the handle normal to the panel. Following installation, the handle may be extended and the handle registration fixture may be removed from the handle.

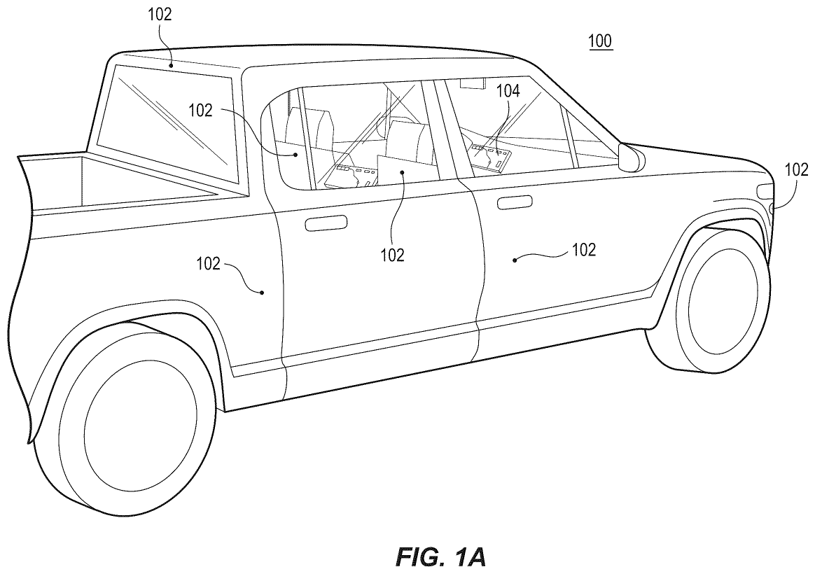

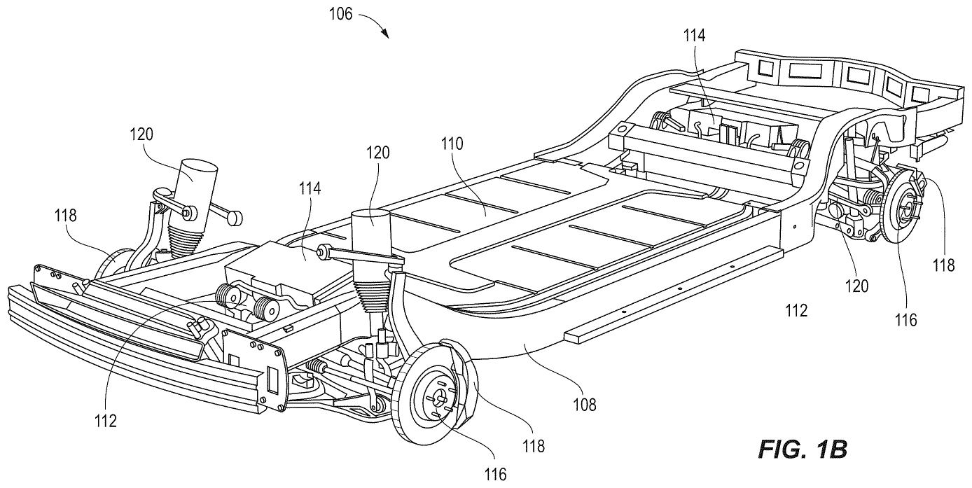

FIG. 1A illustrates an example vehicle 100. As seen in FIG. 1A, the vehicle 100 has multiple exterior cameras 102 and one or more front displays 104. Each of these exterior cameras 102 may capture a particular view or perspective on the outside of the vehicle 100. The images or videos captured by the exterior cameras 102 may then be presented on one or more displays in the vehicle 100, such as the one or more front displays 104, for viewing by a driver.

Referring to FIG. 1B, the vehicle 100 may include a chassis 106 including a frame 108 providing a primary structural member of the vehicle 100. The frame 108 may be formed of one or more beams or other structural members or may be integrated with the body of the vehicle (i.e., unibody construction).

In embodiments where the vehicle 100 is a battery electric vehicle (BEV) or possibly a hybrid vehicle, a large battery 110 is mounted to the chassis 106 and may occupy a substantial (e.g., at least 80 percent) of an area within the frame 108. For example, the battery 110 may store from 100 to 200 kilowatt hours (kWh). The battery 110 may be a lithium-ion battery or other type of rechargeable battery. The battery may be substantially planar in shape.

Power from the battery 110 may be supplied to one or more drive units 112. Each drive unit 112 may be formed of an electric motor and possibly a gear train providing a gear reduction. In some embodiments, there is a single drive unit 112 driving either the front wheels or the rear wheels of the vehicle 100. In another embodiment, there are two drive units 112, each driving either the front wheels or the rear wheels of the vehicle 100. In yet another embodiment, there are four drive units 112, each drive unit 112 driving one of four wheels of the vehicle 100.

Power from the battery 110 may be supplied to the drive units 112 by power electronics 114 of each drive unit 112. The power electronics 114 may include inverters configured to convert direct current (DC) from the battery 110 into alternating current (AC) supplied to the motors of the drive units 112. The power electronics 114 further facilitate operation of the motors of the drive units as generators to provide regenerative braking. The power electronics 114 further facilitate the transfer of regenerative current to the battery 110.

The drive units 112 are coupled to two or more hubs 116 to which wheels may mount. Each hub 116 includes a corresponding brake 118, such as the illustrated disc brakes. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

In the embodiment of FIG. 1B and in the discussion below, the vehicle 100 is a battery electric vehicle. However, the systems and methods disclosed herein may be used for any type of vehicle, including vehicles powered by an internal combustion engine (ICE), hybrid drivetrain, hydrogen fuel cell drivetrain, or other type of drivetrain that may have a portion that is idled during some modes of operation. For example, a front or rear differential of an all-wheel drive vehicle. In another example, in a hybrid drive train, an idled drive unit including an electric motor may be heated with waste heat from an ICE according to the approaches described herein.

FIG. 1A illustrates an example vehicle 100. As seen in FIG. 1A, the vehicle 100 has multiple exterior cameras 102 and one or more front displays 104. Each of these exterior cameras 102 may capture a particular view or perspective on the outside of the vehicle 100. The images or videos captured by the exterior cameras 102 may then be presented on one or more displays in the vehicle 100, such as the one or more front displays 104, for viewing by a driver.

Referring to FIG. 1B, the vehicle 100 may include a chassis 106 including a frame 108 providing a primary structural member of the vehicle 100. The frame 108 may be formed of one or more beams or other structural members or may be integrated with the body of the vehicle (i.e., unibody construction).

In embodiments where the vehicle 100 is a battery electric vehicle (BEV) or possibly a hybrid vehicle, a large battery 110 is mounted to the chassis 106 and may occupy a substantial (e.g., at least 80 percent) of an area within the frame 108. For example, the battery 110 may store from 100 to 200 kilowatt hours (kWh). The battery 110 may be a lithium-ion battery or other type of rechargeable battery. The battery may be substantially planar in shape.

Power from the battery 110 may be supplied to one or more drive units 112. Each drive unit 112 may be formed of an electric motor and possibly a gear reduction drive. In some embodiments, there is a single drive unit 112 driving either the front wheels or the rear wheels of the vehicle 100. In another embodiment, there are two drive units 112, each driving either the front wheels or the rear wheels of the vehicle 100. In yet another embodiment, there are four drive units 112, each drive unit 112 driving one of four wheels of the vehicle 100.

Power from the battery 110 may be supplied to the drive units 112 by one or more sets of power electronics 114. The power electronics 114 may include inverters configured to convert direct current (DC) from the battery 110 into alternating current (AC) supplied to the motors of the drive units 112.

The drive units 112 are coupled to two or more hubs 116 to which wheels may mount. Each hub 116 includes a corresponding brake 118, such as the illustrated disc brakes. The drive units 112 or other component may also provide regenerative braking. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

In the embodiment of FIG. 1B and in the discussion below, the vehicle 100 is a battery electric vehicle. However, the systems and methods disclosed herein may be used for any type of vehicle, including vehicles powered by an internal combustion engine (ICE), hybrid drivetrain, hydrogen fuel cell drivetrain, or other type of drivetrain that requires heating in preparation for use, such as diesel engines.

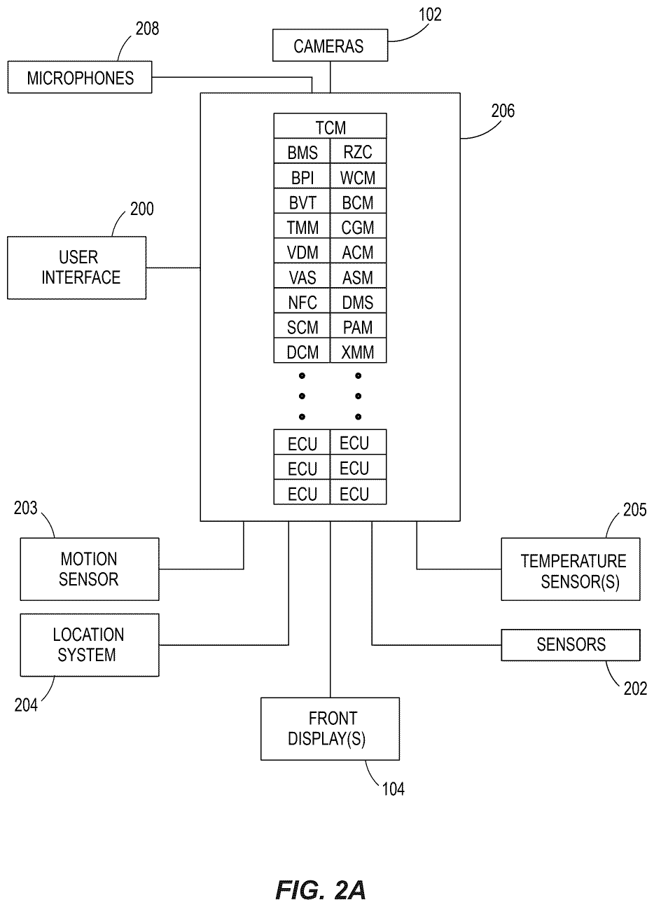

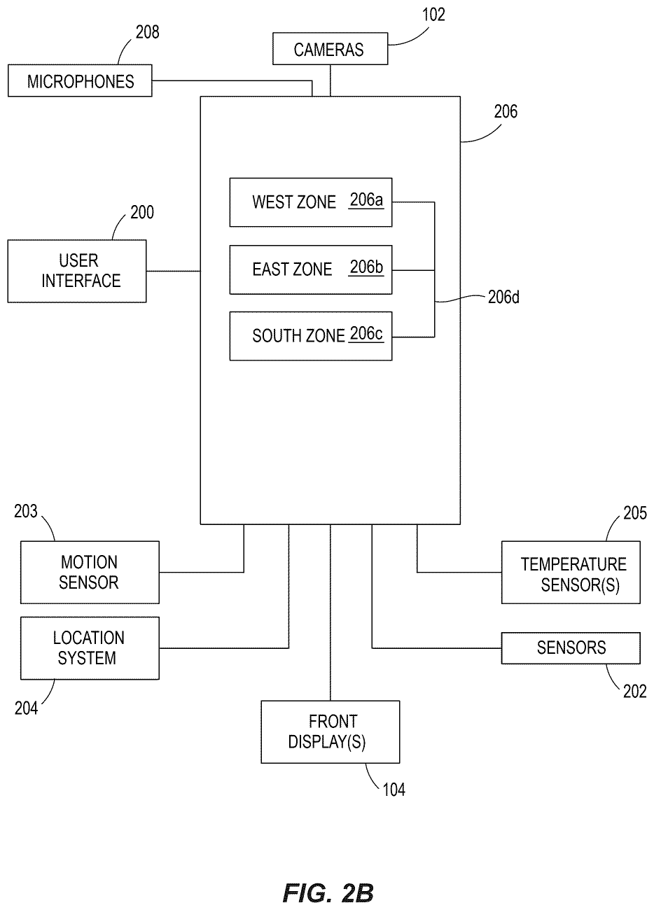

FIG. 2A illustrates example components of the vehicle 100 of FIG. 1A. As shown in FIG. 2A, the vehicle 100 includes the cameras 102, the one or more front displays 104, a user interface 200, one or more sensors 202, a motion sensor 203, and a location system 204. The one or more sensors 202 may include ultrasonic sensors, radio detection and ranging (RADAR) sensors, light detection and ranging (LIDAR) sensors, or other types of sensors. The location system 204 may be implemented as a global positioning system (GPS) receiver and may also include an inertial measurement unit (IMU) (e.g., accelerometers). The user interface 200 allows a user, such as a driver or passenger in the vehicle 100, to provide input.

The components of the vehicle 100 may include one or more temperature sensors 205. The temperature sensors 205 may include sensors configured to sense an ambient air temperature, temperature of the battery 110, temperature of power electronics 114, temperature of each drive unit 112 and/or each motor of each drive unit 112, or the temperature of any other component of the vehicle 100.

A control system 206 executes instructions to perform at least some of the actions or functions of the vehicle 100, including the functions described below. For example, as shown in FIG. 2, the control system 206 may include one or more electronic control units (ECUs) configured to perform at least some of the actions or functions of the vehicle 100, including the functions described below. In certain embodiments, each of the ECUs is dedicated to a specific set of functions. Each ECU may be a computer system and each ECU may include functionality described below.

Certain features of the embodiments described herein may be controlled by a Telematics Control Module (TCM) ECU. The TCM ECU may provide a wireless vehicle communication gateway to support functionality such as, by way of example and not limitation, over-the-air (OTA) software updates, communication between the vehicle and the internet, communication between the vehicle and a computing device, in-vehicle navigation, vehicle-to-vehicle communication, communication between the vehicle and landscape features (e.g., automated toll road sensors, automated toll gates, power dispensers at charging stations), or automated calling functionality.

Certain features of the embodiments described herein may be controlled by a Central Gateway Module (CGM) ECU. The CGM ECU may serve as the vehicle's communications hub that connects and transfer data to and from the various ECUs, sensors, cameras, microphones, motors, displays, and other vehicle components. The CGM ECU may include a network switch that provides connectivity through Controller Area Network (CAN) ports, Local Interconnect Network (LIN) ports, and Ethernet ports. The CGM ECU may also serve as the master control over the different vehicle modes (e.g., road driving mode, parked mode, off-roading mode, tow mode, camping mode), and thereby control certain vehicle components related to placing the vehicle in one of the vehicle modes.

In various embodiments, the CGM ECU collects sensor signals from one or more sensors of vehicle 100. For example, the CGM ECU may collect data from cameras 102 and sensors 202. The sensor signals collected by the CGM ECU are then communicated to the appropriate ECUs for performing, for example, the operations and functions described below.

The control system 206 may also include one or more additional ECUs, such as, by way of example and not limitation: a Vehicle Dynamics Module (VDM) ECU, an Experience Management Module (XMM) ECU, a Vehicle Access System (VAS) ECU, a Near-Field Communication (NFC) ECU, a Body Control Module (BCM) ECU, a Seat Control Module (SCM) ECU, a Door Control Module (DCM) ECU, a Rear Zone Control (RZC) ECU, an Autonomy Control Module (ACM) ECU, an Autonomous Safety Module (ASM) ECU, a Driver Monitoring System (DMS) ECU, and/or a Winch Control Module (WCM) ECU. If vehicle 100 is an electric vehicle, one or more ECUs may provide functionality related to the battery pack of the vehicle, such as a Battery Management System (BMS) ECU, a Battery Power Isolation (BPI) ECU, a Balancing Voltage Temperature (BVT) ECU, and/or a thermal Management Module (TMM) ECU. In various embodiments, the XMM ECU transmits data to the TCM ECU (e.g., via Ethernet, etc.). Additionally or alternatively, the XMM ECU may transmit other data (e.g., sound data from microphones 208, etc.) to the TCM ECU.

Referring to FIG. 2B, in some embodiments, the control system 206 may be implemented as a plurality of zonal controllers 206a, 206b, 206c. Each zonal controller 206a, 206b, 206c may control a subset of systems of the vehicle. The subset of systems controlled by each zonal controller 206a, 206b, 206c may be generally assigned based on location within the vehicle 100. For example, a west zonal controller 206a may control systems on a driver side of the vehicle 100, an east zonal controller 206b may control systems on a passenger side of the vehicle 100, and a south zonal controller 206c may control systems in a rear portion of the vehicle. Each zonal controller 206a, 206b, 206c may implement a portion of the functions ascribed to the ECUs of the control system 206 of FIG. 2A. The functions of the ECUs may be distributed among the zonal controller 206a, 206b, 206c such that only one zonal controller 206a, 206b, 206c implements the functions of each ECU. Alternatively, the functions of an ECU may be duplicated across multiple zonal controllers 206a, 206b, 206c, each zonal performing the functions of the ECU for the portion of the vehicle to which that zonal controller 206a, 206b, 206c is assigned.

The zonal controllers 206a, 206b, 206c may be connected to one another by a network 206d, such as an Ethernet network, controller area network (CAN), or other type of network.

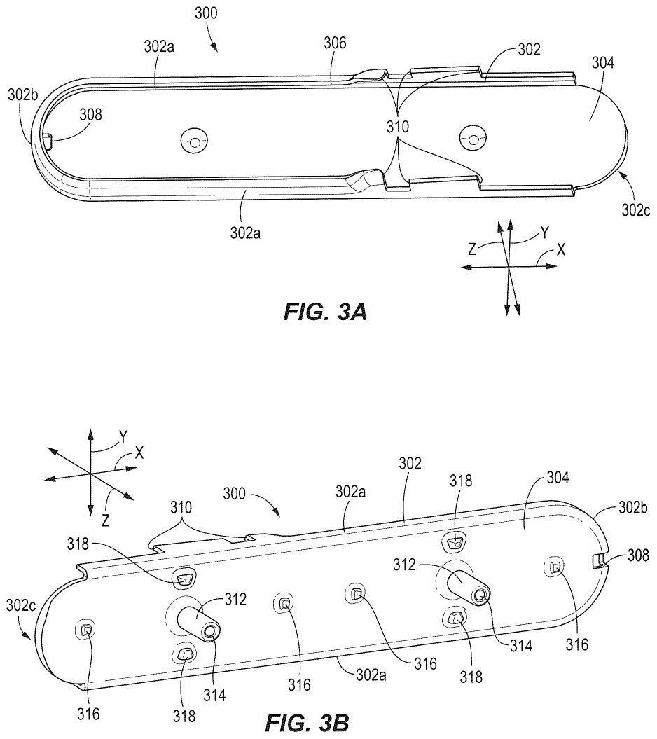

FIGS. 3A and 3B illustrate a handle registration fixture 300 that may be used to maintain the position of a handle with respect to a panel of a vehicle, e.g., a door panel, during assembly. As discussed in greater detail below, the handle may be a flush mounted handle that will benefit from the precise positioning enabled by the handle registration fixture 300. The handle registration fixture 300 may be understood with respect to X, Y and Z directions that are mutually perpendicular to one another. The X, Y, and Z directions are used to indicate relative position and orientation of components but need not indicate actual orientation during use.

The handle registration fixture 300 may include a lateral clearance member 302. The lateral clearance member 302 is shaped to extend around a major portion of the perimeter of a handle in a plane parallel to the X and Y directions (“the X-Y plane”), e.g., at least 60, 80, or 90 percent of a perimeter of the handle. The thickness of the lateral clearance member 302 may be selected to be a fraction of a minimum gap thickness between the handle and an opening in a panel in which the handle is mounted, such as 90, 95, or 100 percent of the minimum gap thickness. The thickness of the lateral clearance member 302 may be defined as being measured along a vector normal to a point on the outward facing surface of the lateral clearance member 302 and parallel to the X-Y plane.

In the illustrated embodiment, the lateral clearance member 302 is a continuous strip of material conforming to the perimeter of the handle in the X-Y plane. However, the lateral clearance member 302 may also be implemented by a series of separate members distributed along a shape conforming to the perimeter of the handle in the X-Y plane.

The handle registration fixture 300 may include a longitudinal positioning member 304 that facilitates positioning of the handle along the Z direction relative to a panel of the vehicle. The longitudinal positioning member 304 may cooperate with a retention member 306 to secure the handle within the handle registration fixture 300.

For example, the longitudinal positioning member 304 may be a layer of material having the lateral clearance member 302 secured thereto and extending outwardly therefrom in the Z direction. In some embodiments, to facilitate insertion of the longitudinal positioning member 304 through an opening in a panel of a vehicle, the longitudinal positioning member 304 does not extend outwardly from the outward facing surface of the lateral clearance member 302 in the X-Y plane.

The retention member 306 may be embodied as a ridge secured to the lateral clearance member 302 and offset from the longitudinal positioning member 304 along the Z direction. A portion of the handle may therefore be inserted between the retention member 306 and the longitudinal positioning member 304 when the handle abuts the inward facing surface of the lateral clearance member 302. Insertion of the handle may require deflection of the retention member 306 such that a biasing force exerted by material forming the retention member 306 and/or the lateral clearance member 302 retains the handle within the handle registration fixture 300. In other embodiments, no deflection is required for insertion.

The retention member 306 may extend around a major portion of the lateral clearance member 302, such as at least 50 percent. For example, as shown in FIGS. 3A and 3B, the lateral clearance member 302 may define an oblong shape including straight portions 302a substantially (e.g., within 0.5 degrees) parallel to one another and to the X direction and a curved portion 302b (e.g., semicircular) extending between the straight portions 302a in the X-Y plane. The lateral clearance member 302 may be absent from a region 302c along the longitudinal positioning member 304 at an opposite end from the curved portion 302b. The region 302c may facilitate insertion of a handle between the straight portions 302a along the X direction. The longitudinal positioning member 304 may have a rounded shape along the region 302c conforming to the shape of the handle in order to protect the handle from contact during installation as discussed in greater detail below.

In some embodiments, the separation between the straight portions 302a provides an interference fit with respect to the handle when inserted within the handle registration fixture 300 in order to resist removal of the handle registration fixture. For example, the separation between the straight portions 302 a may be such that a force of at least 1, 2, or 4 Newtons is required to remove the handle registration fixture 300 once the handle is fully inserted therein (e.g., abutting the curved portion 302b). The removal forces listed above may also be a function of any retention force exerted by deflection of the retention member 306 as discussed.

The handle registration fixture 300 may have various other features formed thereon to facilitate the function thereof. For example, in some embodiments, a window 308 may extend through one end of the lateral clearance member 302 and/or longitudinal positioning member 304 to enable an operator to verify that a handle has been fully inserted into the handle registration fixture. For example, the window 308 may extend through the curved portion 302b and possibly a portion of the longitudinal positioning member 304.

The handle registration fixture 300 may have clearance features 310 formed thereon and providing clearance for portions of a handle assembly including the handle, such as a hinge, latch, pivot shaft, actuator, or other portions of the handle assembly that may be located adjacent the handle registration fixture 300. The clearance features 310 may further ensure that the handle registration fixture 300 is correctly positioned on the handle: if the handle is not fully inserted into the handle registration fixture 300 the clearance features 310 will be misaligned and the handle may be prevented from retracting fully.

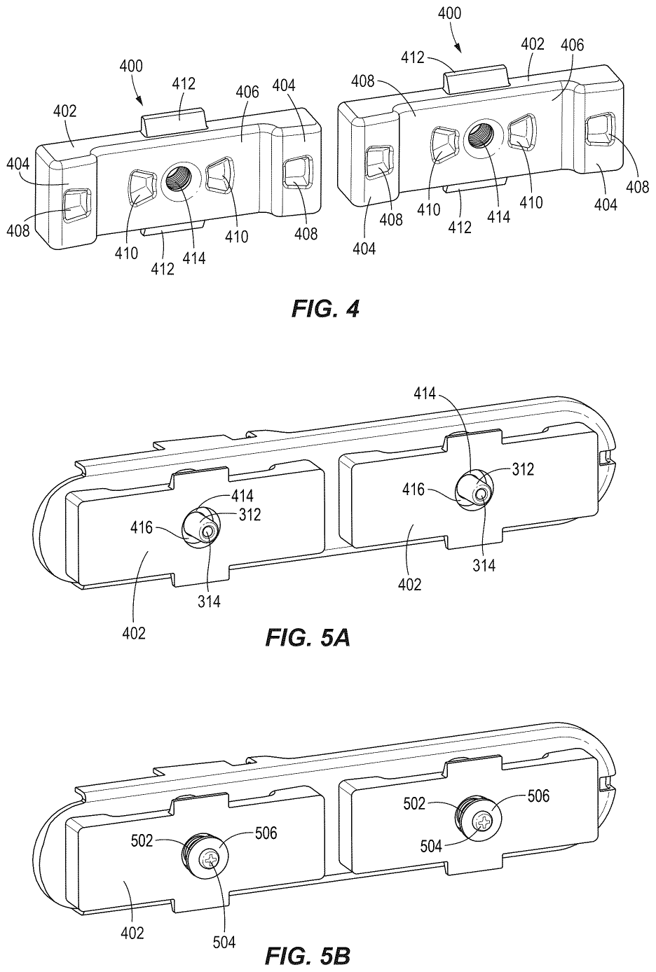

Referring specifically to FIG. 4, while continuing to refer to FIG. 3B, the handle registration fixture 300 may include features for mounting retainers 400 thereto for securing the handle registration fixture 300 to a panel of a vehicle. The features may include one or more mounting posts 312 each defining an opening 314, which may be threaded. The one or more mounting posts 312 may extend outwardly from the longitudinal positioning member 304, such as in the Z direction. The insertion direction of the opening 314, e.g., an axis of rotation for inserting a threaded fastener, may likewise be substantially (e.g., within 0.5 degrees of) parallel to the Z direction.

Each retainer 400 may include a cross member 402 defining feet 404 that extend outwardly on either side of a recessed surface 406, e.g., along the Z direction when mounted to the handle registration fixture 300. The feet 404 and recessed surface 406 may be substantially (e.g., within 0.5 degrees) parallel to one another, e.g., in the X-Y plane when mounted to the handle registration fixture 300. The width of the recessed surface 406 between the feet 404 may correspond to a width of the handle registration fixture 300 in the Y direction and/or contour of the handle registration fixture 300 in a plane parallel to the Y and Z directions (the Y-Z plane), such as a portion of the handle registration fixture 300 that is positioned in the X direction along the straight portions 302a of the lateral clearance member 302. In either case, when the extent of the recessed surface 406 may be such that the recessed surface may be positioned in contact with the longitudinal positioning member 304 with the feet 404 positioned on either side of the handle registration fixture 300.

The difference in position along the Z direction between the feet 404 and the recessed surface 406 may be selected to achieve a desired position of the handle relative to an outer surface of a panel of a vehicle with which the feet 404 are engaged. For example, the difference in position along the Z direction between the feet 404 and the recessed surface 406 may be substantially (e.g., +/−5%, +/−2%, or +/−1%) equal to a thickness of the longitudinal positioning member 304 in the Z direction.

A registration feature 408 may be defined on each foot 404 and be positioned and sized to engage corresponding registration features 316 formed on the longitudinal positioning member 304. Registration features 410 may be defined on the recessed surface 406 and be positioned and sized to engage corresponding registration features 318 formed on the longitudinal positioning member 304. In the illustrated embodiment, the registration features 408, 410 are recesses and the registration features 316, 318 are protrusions. However, other configurations are possible, such as any one or more registration features 408, 410 may be protrusions and the corresponding one or more registration features 316, 318 may then be implemented as recesses.

When embodied as a protrusion, each registration feature 316, 318, 408, 410 may be tapered, e.g., decreasing in thickness in planes parallel to the X-Y plane with distance from the longitudinal positioning member 304 in the Z direction when the retainers are secured to the longitudinal positioning member 304. When embodied as protrusion, the protrusion may have the illustrated truncated sector shape with rounded corners. When embodied as recesses, the recess may likewise have the illustrated truncated sector shape with rounded corners sized to receive a corresponding protrusion.

The cross member 402 may define one or more grips 412. The grips 412 may facilitate grasping of the retainer 400 by the fingers of a user or automated actuator. In the illustrated embodiment, the grips 412 project outwardly from the cross member 402 in the Y direction when the retainer 400 is mounted to the handle registration fixture 300 with the feet 404 offset from one another along the X direction. The grips may have sloped surfaces in the Y-Z plane, e.g., sloping away from the recessed surface 406 in an opposite direction from the direction that the feet 404 extend outwardly from the recessed surface 406.

The cross member 402 may further define an opening 414 for receiving a mounting post 312. The opening 414 may be countersunk such that the opening 414 defines a shoulder 416.

The handle registration fixture 300 may be made of a material selected so as not to scratch paint of a panel to which a handle is being mounted using the handle registration fixture 300. For example, the handle registration fixture 300 may be made of DELRIN, nylon, plastic for use in a three-dimensional printing process (e.g., SOMOS EVOLVE 128, polylactic acid (PLA)), or other type of plastic. The feet 404 may be coated with a different material (e.g., a different plastic) or have pieces of a different material secured thereto as compared to other portions of the handle registration fixture 300, e.g., a softer plastic, in order to reduce the risk of scratches.

Referring to FIGS. 5A and 5B, while still referring to FIG. 4, installation of a retainer 400 with respect to the handle registration fixture 300 may include inserting a mounting post 312 into the opening 414. As shown in FIG. 5A, the shoulder 416 extends outwardly from the mounting post 312. A spring 502 may be positioned abutting the shoulder 416. A fastener 504, such as a screw, may be inserted into the opening 314 in order to retain the spring 502. A washer 506 may be positioned between the screw and the spring 502 to facilitate retention of the spring 502. The spring 502 may be compressed during installation and therefore bias the retainer 400 toward the longitudinal positioning member 304. The extent of the mounting post 312 above the shoulder 416 in the Z direction may larger than the stack height of the spring 502 by an amount that is at least as large as the difference in the positions of the feet 404 and recessed surface 406 along the Z direction. Therefore, the retainer 400 may be positioned with the feet 404 resting on the longitudinal positioning member 304 or with the recessed surface 406 resting on the longitudinal positioning member 304.

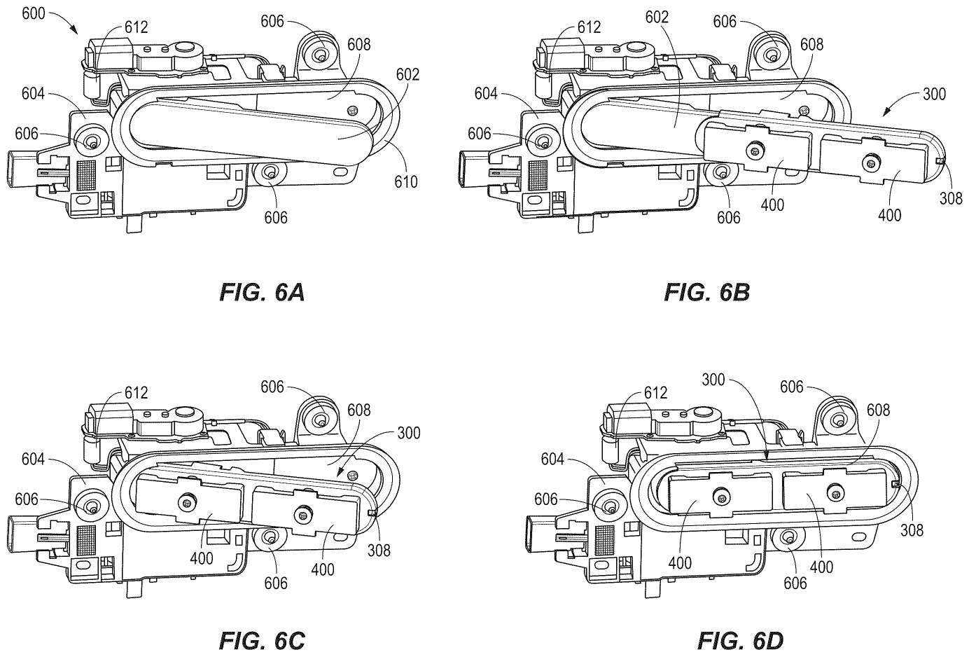

FIGS. 6A to 6D illustrate a handle assembly 600 with corresponding handle 602 that may have the handle registration fixture 300 mounted thereto. Referring specifically to FIG. 6A, the handle assembly 600 may include a mounting bracket 604 having one or more fasteners 606 mounted thereto. The fasteners 606 may be tolerance compensation fasteners that are able to compensate for positioning differences in at least one dimension and possibly three dimensions. For example, the fasteners 606 may be implemented as a WITOL HELIX fastener, a FLEXITOL fastener manufactured by Böllhoff, or other type of tolerance compensation fastener. Using the precise positioning offered by the handle registration fixture 300, any other positioning errors may be compensated by the compensation range of the tolerance compensation fasteners 606.

The handle assembly 600, e.g., the mounting bracket 604, may define a seat 608 in which the handle 602 is positioned when not extended (see FIG. 6D). The seat 608 may include a seal 610 around the perimeter thereof, the seal 610 engaging an inner surface of the panel of the vehicle to which the handle assembly 600 is secured. The seal 610 may deflect upon installation. The force exerted by the springs 502 may be sufficient to deflect the seal 610 sufficiently to bring the handle 602 into a correct position relative to the panel of the vehicle as discussed in greater detail below as well as create at least a predefined amount of sealing pressure.

The handle assembly 600 may include an actuator 612 configured to move the handle 602 between an extended position (FIG. 6A) and a retracted position (FIG. 6D). The handle 602 may also be manually movable from the retracted position to the extended position, such as by pressing on one end of the handle 602 (e.g., the left end in FIG. 6A). A hinge point of the handle relative to the seat 608 may be offset from the left end, for example, such that pressure on the left end will cause the right end to pivot outwardly.

Referring specifically to FIG. 6B, with the handle 602 in the extended position, the handle registration fixture 300 may be slid onto the handle 602. For example, the region 302c where the lateral clearance member 302 is absent may be positioned over the end of the handle 602 extending outwardly from the seat 608 (the right end in FIG. 6B) and the handle 602 may be inserted between the straight portions 302a of the lateral clearance member 302 and between the retention member 306 and the longitudinal positioning member 304. The insertion direction may be substantially (e.g., within 10 degrees of) parallel to the X direction (see definition of X direction in FIGS. 3A and 3B).

FIG. 6C illustrates the handle registration fixture 300 with the handle 602 fully inserted. As noted above, full insertion may be verified visually by observing that the end of the handle 602 is visible in the window 308.

Referring to FIG. 6D, following insertion, the handle 602 may be returned to the retracted position, either manually or due to a biasing mechanism in the actuator 612. To facilitate insertion through an opening in the panel of the door of the vehicle, the retainers 400 may be oriented as illustrated (“the aligned position”) with the feet 404 resting on the longitudinal positioning member 304, e.g., the registration features 408 engaged with the registration features 316.

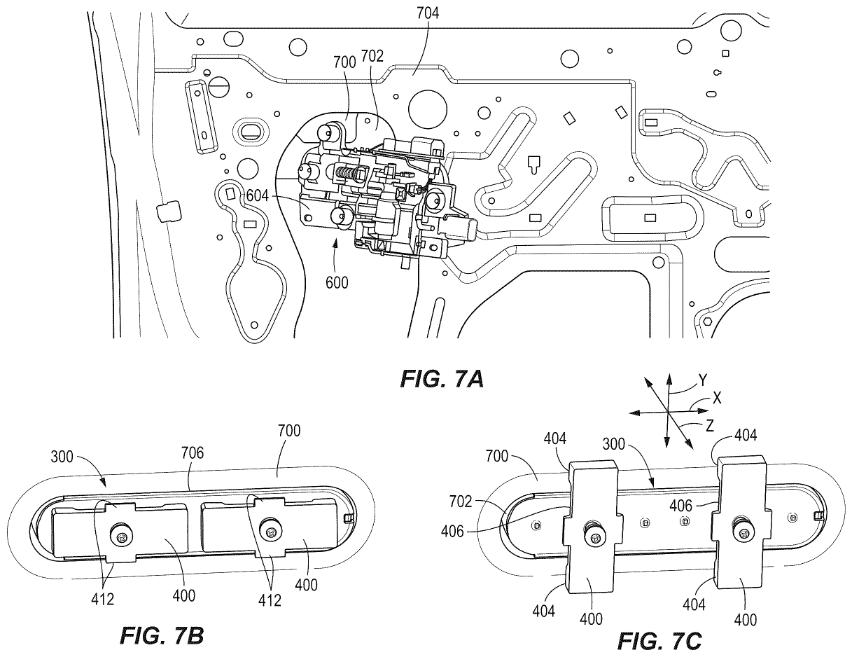

FIGS. 7A to 7D illustrate the use of the handle registration fixture 300 to install the handle assembly 600 onto a panel 700 of a vehicle in accordance with certain embodiments. The panel 700 may be part of the illustrated door. The panel 700 may have an intermediate bracket 702 secured thereto, such as by welding. The intermediate bracket 702 may serve as a mounting point for the mounting bracket 604 of the handle assembly. The intermediate bracket 702 may be positioned between the panel 700 and an internal panel 704, which may serve as an attachment point for interior trim, switches, speakers, or other internal components of the vehicle.

Referring to FIG. 7A, as an initial step, the handle assembly may be inserted between the internal panel 704 and the intermediate bracket 702 and the handle 602 along with the handle registration fixture 300 may be inserted through an opening 706 in the panel 700, as shown in FIG. 7B. As shown in FIG. 7A, the handle 602 and handle registration fixture 300 are inserted from the inner surface of the panel 700. The retainers 400 may be rotated, e.g., about (e.g., within 5 degrees of) 90 degrees, from the aligned position to the illustrated position (“the cross position”) of FIG. 7C. In the cross position, the feet 404 extend outwardly from the lateral clearance member 302 and longitudinal positioning member 304, e.g., in the Y direction. The spring 502 urges the retainer 400 toward the longitudinal positioning member 304, such as until the recessed surface 406 contacts the longitudinal positioning member 304. In the cross position, the registration features 318 are engaged with the registration features 410 (see FIGS. 3B and 4). In the cross position the feet 404 may rest against an outer surface of the panel 700 and the force of the spring 502 may compress the seal 610 against the inner surface of the panel 700. For example, in the cross position, when deflected to the position where the recessed surface 406 contacts the longitudinal positioning member 304, each spring 502 may exert at least 20, 30, or 35 Newtons of force. The force exerted by the springs 502 may be limited to be not greater than 40 Newtons of force to avoid significant deflection of the panel 700 itself. As another metric defining the strength of the springs 502, the weight of the handle assembly 602 (e.g., from 1.5 to 2.5 kg) tending to remove the handle 602 from the opening may be resisted by the biasing of the springs 502.

In the configuration of FIG. 7C, the force of the spring 502 urges the outer surface of the handle 602 along the Z direction to be flush, within a predefined tolerance, with the panel 700. Likewise, the lateral clearance member 302 maintains a gap between the handle 602 and the opening 706 within a predefined tolerance of a desired alignment in the X and/or Y directions. The mounting bracket 604 may then be secured to the intermediate bracket 702 using the fasteners 606. Misalignment between the mounting bracket 604 and the intermediate bracket 702, particularly along the Z direction, may be compensated for by the tolerance compensating properties of the fasteners 606.

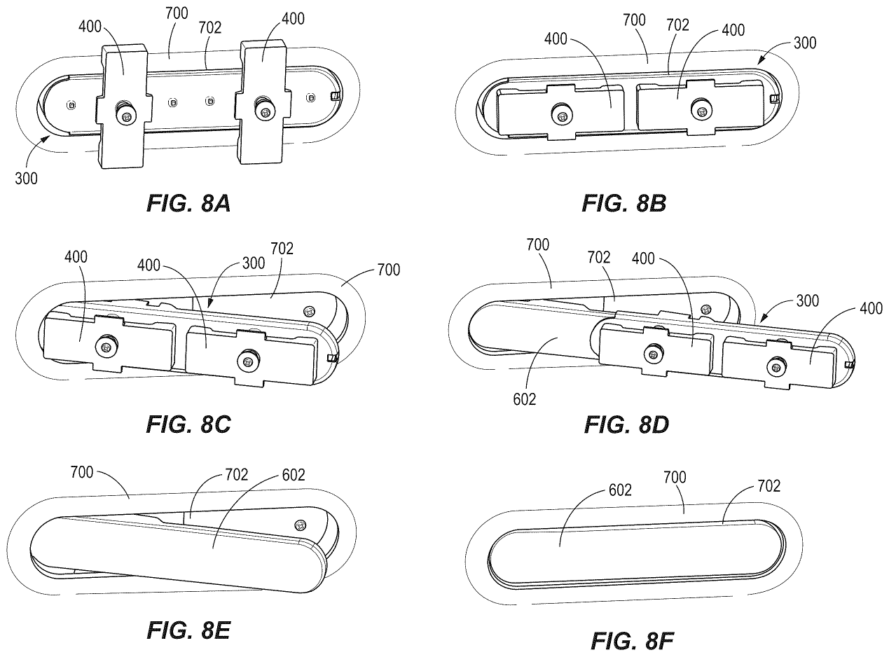

FIGS. 8A to 8F illustrate the process of removing the handle registration fixture 300. The retainers 400 are returned to the aligned position as shown by FIGS. 8A and 8B. Transitioning each retainer 400 may be accomplished by a user pulling outwardly on the grips 412 to disengage the registration features 410 from the registration features 318, rotating the retainers 400 to the aligned position, and releasing the grips 412 such that the spring 502 urges the registration features 408 into engagement with the registration features 316.

As shown in FIG. 8C the user may then extend the handle 602 outwardly from the outer surface of the panel 700, such as by pressing on one end of the handle 602 (e.g., the left end in FIG. 8C) and then slide the handle registration fixture off of the handle 602 as shown in FIG. 8D. The handle 602 is then returned to the retracted position as shown in FIGS. 8E and 8F due to a biasing mechanism in the actuator 612, operation of a motor within the actuator 612, or by manually pressing the handle 602 toward the panel 700.

As is apparent from the above description, the handle registration fixture 300 and the corresponding method of use thereof enables the precise positioning of a flush mounted handle 602 relative to a panel 700. As is also apparent, the handle registration fixture 300 can be rapidly engaged with and disengaged from the handle 602 without the use of tools. The precise installation of the door handle assembly 600 is therefore accomplished quickly without additional fixtures or other requipment.

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a one or more computer processing devices. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Certain types of storage devices that include these mediums include: diskette, hard disk, random access memory (RAM), read only memory (ROM), erasable programmable read only memory (EPROM or Flash memory), static random access memory (SRAM), compact disc read only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, refers to non-transitory storage rather than transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but the storage device remains non-transitory during these processes because the data remains non-transitory while stored.

While the foregoing is directed to embodiments of the present disclosure, other and further embodiments may be devised without departing from the basic scope thereof, and the scope thereof is determined by the claims that follow.

What is claimed is:

1. A fixture comprising:
a lateral clearance member configured to receive a handle and occupy a gap between the handle and an opening defined by a panel;
a longitudinal positioning member secured to the lateral clearance member and configured to position the handle in a longitudinal direction perpendicular to the opening; and
one or more retainers secured to the longitudinal positioning member and configured to selectively draw the longitudinal positioning member into alignment with the opening along the longitudinal direction.

2. The fixture of claim 1, further comprising a retention member offset from the longitudinal positioning member along the longitudinal direction and configured to retain the handle between the retention member and the longitudinal positioning member.

3. The fixture of claim 2, wherein:
the lateral clearance member comprises a first straight portion and a second straight portion substantially parallel to and coextensive with the first straight portion; and
the retention member comprises a first ridge extending inwardly from the first straight portion a second ridge extending inwardly from the second straight portion.

4. The fixture of claim 3, wherein the longitudinal positioning member comprises a sheet of material extending between the first straight portion and the second straight portion.

5. The fixture of claim 3, wherein:
the lateral clearance member further comprises an end portion extending between the first straight portion and the second straight portion;
the retention member comprises an end ridge extending inwardly from the end portion; and
the longitudinal positioning member comprises a sheet of material extending between the first straight portion, the second straight portion, and the end portion.

6. The fixture of claim 5, wherein the lateral clearance member defines a window enabling viewing of the handle when fully inserted into the lateral clearance member.

7. The fixture of claim 1, wherein the one or more retainers each comprise:
a cross member defining a first foot and a second foot and a recessed surface between the first foot and the second foot, the recessed surface being recessed relative to the first foot and the second foot along the longitudinal direction.

8. The fixture of claim 7, wherein the one or more retainers further comprise a biasing member configured to urge the recessed surface into engagement with the longitudinal positioning member when the first foot and the second foot are positioned outwardly from the longitudinal positioning member.

9. The fixture of claim 8, wherein:
the one or more retainers each define one or more first retention features; and
the longitudinal positioning member defines one or more second retention features configured to engage the one or more first retention features when the first foot and the second foot are positioned outwardly from the longitudinal positioning member, the engagement of the one or more second retention features with the one or more first retention features resisting rotation of each retainer of the one or more retainers.

10. The fixture of claim 9, wherein:
the one or more retainers each define one or more third retention features; and
the longitudinal positioning member defines one or more fourth retention features configured to engage the one or more third retention features when the first foot and the second foot are positioned over the longitudinal positioning member, the engagement of the one or more fourth retention features with the one or more third retention features resisting rotation of each retainer of the one or more retainers.

11. The fixture of claim 9, wherein the one or more first retention features include one or more recesses and the one or more second retention features include one or more protrusions configured to insert within the one or more recesses.

12. A method for installation comprising:
fitting a lateral clearance member onto a handle of a handle assembly;
inserting the handle and lateral clearance member into an opening in a panel such that that lateral clearance member maintains a gap between the handle and the opening;
mounting the handle assembly to the panel;
extending the handle from the opening following mounting of the handle assembly to the panel; and
removing the lateral clearance member from the handle.

13. The method of claim 12, wherein the lateral clearance member is part of a handle registration fixture including a longitudinal positioning member engaging the handle and having one or more retainers mounted thereto, the method further comprising:
engaging the one or more retainers with the panel while the handle assembly is positioned on an opposite side of the panel from the one or more retainers to position the handle in a normal direction relative to the panel.

14. The method of claim 13, wherein engaging the one or more retainers comprises twisting the one or more retainers from an aligned position in which the one or more retainers are positioned to insert through the opening to a cross position in which the one or more retainers extend outwardly from the longitudinal positioning member and engage the panel.

15. The method of claim 14, wherein engaging the one or more retainers comprises compressing a seal of the handle assembly extending around the opening.

16. The method of claim 14, wherein a biasing member is configured to urge the one or more retainers toward the longitudinal positioning member.

17. The method of claim 12, wherein:
inserting the handle and the lateral clearance member into the opening in the panel comprises inserting the handle and lateral clearance member into the opening from a first side of the panel; and
extending the handle from the opening following mounting of the handle assembly to the panel comprises extending the handle outwardly from a second side of the panel opposite the first side.

18. The method of claim 17, wherein mounting the handle assembly to the panel comprises mounting the handle assembly to an intermediate bracket secured on the first side of the panel.

19. The method of claim 12, wherein the handle comprises an actuator configured to extend the handle from the opening.

20. The method of claim 12, wherein mounting the handle assembly to the panel comprises mounting the handle assembly to the panel using tolerance compensating fasteners.
